(19) United States
(12) Patent Application Publication
(10) Pub. No.: US 2002/0156725 A1
(43) Pub. Date: Oct. 24, 2002

(54) Method and means for conducting cashless financial transactions

(76) Inventor: Marwan Ahmed Harara, Redwood City, CA (US)

Correspondence Address: MARWAN AHMED HARARA, P.O. BOX 590651, SAN FRANCISCO, CA, 94159, US

(21) Appl. No.: 09/839,838

(22) Filed: Apr. 23, 2001

(51) Int. Cl. G06F 17/60

(52) U.S. Cl. 705/39

(57) ABSTRACT

The invention discloses a financial transaction system without use of cash or credit cards. It is based on tangible or intangible media having a pre-designated monetary value attached to them. In addition, the invention provides a new method for conducting financial transaction online or offline anonymously without use of cash. It also provides for creating monetary value attached to media without disclosure of personal information of the holder. Such methods may further be secured by indicia designated by the holder and recognized by the issuer credit card company, financial institution or bank. Personal information may be attached to the medium where it can be sub classified under existing accounts with the credit card company, financial institution or bank.

### BACKGROUND OF THE INVENTION

1. Field of the Invention

The invention describes a new approach for conducting financial transactions without use of cash or credit cards. This invention allows for cashless transactions. Purchasing or obtaining services are exchanged for monetary value that is attached to a medium. The said medium does not identify the identity of entity or person holding the monetary value attached to it. Therefore, transactions will be conducted without the need to identify the customer, as is the case with credit cards or debit cards. This aspect of this invention affords transacting parties the advantage not to disclose personal information as that afforded in cash transactions.

2. Description of the Related Art

Most financial transactions involve the exchange of a commodity by performing services or offering goods for another commodity in the form of a mutually accepted consideration. The services and goods offered as a commodity are indefinite. The return commodity in the form of a mutually accepted consideration may have an indefinite variable value but it has only one of a few known financial forms. The most widely used and accepted financial form of consideration is cash. Almost all commodities, goods and services, are exchanged for cash. Another form of financial consideration is credit cards where a financial institution, bank or credit card company based on the good credit standing of the consumer guarantees payment for the commodity offered in return for an annual credit card membership fee, or an interest rate added to the said guaranteed payment.

There are other forms of considerations that were developed through time as an alternative for cash or credit cards. Checks issued by banks are a form of financial consideration or value that is drawn against an established fund or known cash account balance of the check holder with the issuing bank. Another form of financial consideration is money orders or travelers checks where a sum of cash is exchanged for an attached value of cash to a paper form in return for a fee. This allows for exchanging cash value by use of a tangible form without the use of cash which may facilitate financial transactions and reduce fraud or theft.

Except cash, all of the aforementioned forms of financial considerations identify the owner or value holder. Credit cards, checks, money orders are issued to a known and identifiable consumer who must reveal additional personal information to establish a bank or credit card account. Digits and numbers identifying a certain credit card account, and increasingly bank checking accounts, can be used without use of the actual tangible medium of the plastic form of the credit card or the paper form of the check. This invention combines the aspect of anonymity attached to use of cash in financial transactions and that of using digits and numbers to identify a fixed monetary value, commodity value, consideration or to draw an amount of money against an established, prepaid find, monetary balance or value.

The following patents describe certain aspects of the current state of financial transactions but they all lack the novel aspect of combining the element of anonymity afforded to cash holders with the advantage of designating digits and numbers to known monetary value which can be transmitted online or offline and by use or without use of tangible media.

Nagata, U.S. Pat. No. 4,197,986 pertains to a transaction system wherein a single credit card associated with a single account can be used in transaction with any one of on-line and off-line computer facilities. The Nagata invention is based on the identification of the consumer and thus is entirely distinguishable from the present invention.

Brody, U.S. Pat. No. 5,350,906 discloses a currency transfer system and method which utilizes the existing ATM network but which provides for the temporary assignment of a PIN number and the temporary establishment of a credit limit within an existing account. This, again, is based on the identification of the consumer, and therefore, is different than what is disclosed in this invention.

### SUMMARY OF THE INVENTION

Transactions are increasingly conducted via media that forces the consumer to disclose personal information irrelevant to the transaction. This practice hinders the consumer's ability to conduct transactions through use of credit cards or debit cards where disclosing the identity of the consumer or other personal information are of concern. A consumer who wishes to complete a transaction without disclosing his/her identity or feeding personal information irrelevant to the transaction is forced to tender cash as a return value. In this age where hand-to-hand transactions are becoming less dominating, consummating a financial transaction without divulging the identity or personal information of the consumer is an impossibility.

This invention allows for a cashless hand-to-hand or non-hand-to-hand transactions without identifying transacting party or parties. Simply, this invention involves creating a tangible or intangible medium with an attached certain known monetary value without reference to any other information. The attached monetary value to the said medium will then be exchanged regularly for goods or services through hand-to-hand, non-hand-to-hand, phone, wire, or Internet interactions or transactions.

The present invention is based on the designation of a code, cipher, numbers, sequence of numbers, digits, sequence of digits, symbols, sequence of symbols, signs, sequence of signs or any other indicia that can be communicated online or offline. The said designation will be translated to indicate a fixed amount of monetary value, fund or balance.

In a particularly preferred embodiment, a credit card company, such as Visa, Master Card, American Express, Discover or the like, will issue a one-time money card with a pre-designated fixed monetary value for a charge. The said one-time money card can be used one or repeated times till the pre-designated fixed monetary value is exhausted. At such exhaustion point, the said onetime money card will be disposed. The credit card company will designate a specific code to the one-time money card in the form of digits or numbers that will remain uncovered until the purchase of the said card. The fixed monetary value will be apparent on the face of the said card. The digital or numerical code will be scratched off after purchase by the consumer. The said numerical code or digital code can then be used in any transaction at a location offering commodity in the form of goods or services where any cards issued by the said credit card company are accepted. The credit card company will retail the said one-time money card at banks, affiliated commercial retailers or any commercial retailers. The said credit card company will fix a purchase charge for said one-time money card that will be collected from the purchaser of the said one-time money card once. The said fixed purchase charge or fee will be increased if the value of the pre-designated monetary value of the said one-time money card is increased. A percentage of the said fixed purchase charge or fee will be shared with the commercial retailers of the said one-time money cards. Credit card companies will generate additional income by charging a transactional fee to the transacting party offering commodities in the form of goods or services. The said additional transactional fee is either a fixed surcharge to every transaction involving the said credit card company or a percentage based on the amount charged by the said transacting party offering a commodity in the form of goods or services for using the said one-time money card issued by the said credit card company. So long as there is a remaining monetary balance on the said one-time money card, it will be accepted up to the available remaining value.

In another embodiment, this invention discloses a transaction system comprising a one-time money card having a card balance recorded therein. Withdrawal or use of the attached money value can be effected within the framework of a pre-designated maximum value amount. Each time such transaction has been made, the card balance is updated to read a new card balance. The cardholder can learn of the balance by calling an automated service number and feeding the said card number to get an updated monetary value.

In another aspect, the invention concerns the use of the said one-time money card for immediate transactions that will consume all or most of the pre-designated fixed monetary value as to eliminate fraudulent copying or use by others.

In another preferred embodiment, a bank or a financial institution will issue a money line with a pre-designated fixed monetary value for a charge. The said money line will be issued to the consumer with a fixed Personal Identification Number “PIN” that will be know only to the consumer and verifiable by the bank. Use of the said money line must be associated with entering the PIN number. Use of the said money line cannot be triggered if the consumer forgot the PIN number or entered the wrong PIN number. The said money line can be used one or repeated times till the pre-designated fixed monetary value is exhausted. At such exhaustion point, the said money line will be without value. The bank, financial institution or their affiliates will designate a specific code or indicia to the money line in a form recognized by the bank, the financial institution or their affiliates.

The bank or financial institution will fix a monetary value to the money line as requested by the holder. The bank or the financial institution will affix a PIN number of the choice of the holder which will be verified in every transaction. The PIN number will not reveal the identity of the consumer or any other personal information. The PIN number will serve to confirm the validity of the money line, its fixed monetary value or remaining balance. The said money line can serve to complete transaction online or offline. The money line can serve as a saving account ready for use at a time of emergency. The said money line can be used by the holder by cashing it at any branch of the said bank, financial institution or their affiliates. The said bank or financial institution will fix a purchase charge on said money line that will be collected from the purchaser of the said money line once. The said fixed purchase charge or fee will be increased if the value of the pre-designated monetary value of the said money line is increased. Additional charges may be taxed in the form of transactional fees that are excised directly from the said money line for every transaction. The said additional transactional fee is either a fixed surcharge to every transaction involving the said money line or a percentage based on the amount used of the money line.

### BRIEF DESCRIPTION OF THE DRAWINGS

No drawings are necessary.

### DETAILED DESCRIPTION OF THE PREFERRED EMBODIMENT

I. Definitions

Unless defined otherwise, technical and scientific terms used herein have the same meaning as commonly understood by one of ordinary skill in the art to which this invention belongs. One skilled in the art will recognize many methods and materials similar or equivalent to those described herein, which could be used in the practice of the present invention. Indeed, the present invention is in no way limited to the methods and materials described. For purposes of the present invention, the following terms are defined below.

The term “transaction” refers to any promise to do or act, exchange of promises, offer and acceptance or any relationship dominated by a commercial incentive.

The term “interaction” is used to define a relationship characterized by an exchange for value.

The terms “tangible medium” refers to any method or means capable of being physically sensed.

The term “intangible medium” refers to any method or means that can be recognized but not commonly physically sensed.

II. Description of Preferred Embodiments

In one embodiment, the present invention provides for a credit card company to issue money cards with a pre-designated monetary value for a fixed fee. The said money card will have a coded number that is covered and must be uncovered to permit use. The money card will also have a covered magnetic bar code number to allow use through credit card machines commonly used to charge against credit cards. The money card will not require a distinct transactional system to transfer information. It will be based on existing information transfer systems.

In a preferred embodiment, the issuing company will distribute the money cards with a fixed pre-designated monetary value to retailers. Consumers will purchase such card for commercial use. Retailers will share part of the fixed fee charged to purchase the money card. Consumers exchange the cash tangible value to a more flexible monetary value that can be transferred online or offline.

In another preferred embodiment, the said intangible monetary value can be transmitted to any other user by reading the numbers on the said monetary card which will then be fed into a credit card machine to dispense the balance of the pre-designated monetary value. Use of the monetary card through a credit card machine will be for a charge. The said charge can be taxed against the holder of the said money card if cash is dispensed in exchange. The charge can also be taxed against the holder of the said money card and the party exchanging goods or services in a manner similar to charges normally taxed by credit card companies.

Alternatively, the said intangible monetary value can be transmitted by passing the magnetic bar code through a credit card machine to dispense the balance of the pre-designated monetary value. Use of the monetary card through a credit card machine will be for a charge. The said charge can be taxed against the holder of the said money card if cash is dispensed in exchange. The charge can also be taxed against the holder of the said money card and the party exchanging goods or services in a manner similar to charges normally taxed by credit card companies.

Similarly, the said intangible monetary value can be transmitted by entering the numerical code into a credit card machine to dispense or cash the pre-designated fixed monetary value or the balance of the pre-designated monetary value. Every use of the monetary card through a credit card machine will be for a charge. The said charge can be taxed against the holder of the said money card when cash is dispensed.

In a preferred embodiment, a money line is issued by a bank secured by a bank-recognizable secret PIN number or indicia chosen by the consumer. The money line will serve as intangible, fixed, pre-designated monetary value that is capable of being cashed at any branch of the bank or affiliated financial institution.

In a less preferred embodiment, the said money line can be identified with personal information. While it is preferred not to track the money line by identifying the consumer through personal information, non-anonymous money lines can be issued, traced and secured when requested by the consumer. They can be attached to existing accounts and accessed through issued cards.

All references cited throughout the specification are hereby expressly incorporated by reference. It is understood that the application of the teachings of the present invention to a specific problem or situation will be within the capabilities of one having ordinary skill in the art in light of the teachings contained herein. Examples of the products of the present invention and representative processes for their production and use should not be construed to limit the invention.

What is claimed is:

1. A method of transaction comprised of a pre-designated monetary value attached to a tangible or intangible medium that can be identified through recognized means unrelated to persons' personal information, including name, social security number or birth date.

2. The method set forth in claim 2 wherein the said tangible or intangible medium or its pre-designated monetary value will be exchanged for a fee.

3. The method set forth in claim 2 wherein the said tangible or intangible medium or its pre-designated monetary value will be used online or offline.

4. The method set forth in claim 2 wherein the said tangible or intangible medium or its pre-designated monetary value will be used as a commodity.

5. The method set forth in claim 2 wherein the said tangible or intangible medium or its pre-designated monetary value will be exchanged to obtain goods or services.

6. The method set forth in claim 2 wherein the said tangible or intangible medium or its pre-designated monetary value will be cashed.

7. The method set forth in claim 2 wherein the said tangible or intangible medium carrying a pre-designated monetary value will be issued by a credit card company, financial institution or a bank.

8. A tangible or an intangible medium having a pre-designated monetary value attached to it that can be can be identified through recognized means unrelated to persons' personal information, including name, social security number or birth date.

9. The medium set forth in claim 8 wherein the said tangible or intangible medium or its pre-designated monetary value will be exchanged for a fee.

10. The medium set forth in claim 8 wherein the said tangible or intangible medium or its pre-designated monetary value will be used online or offline.

11. The medium set forth in claim 8 wherein the said tangible or intangible medium or its pre-designated monetary value will be used as a commodity.

12. The medium set forth in claim 8 wherein the said tangible or intangible medium or its pre-designated monetary value will be exchanged to obtain goods or services.

13. The medium set forth in claim 8 wherein the said tangible or intangible medium or its pre-designated monetary value will be cashed.

14. The medium set forth in claim 8 wherein the said tangible or intangible medium or its pre-designated monetary value will be issued by a credit card company, financial institution or a bank.

15. A tangible or an intangible medium having a pre-designated monetary value attached to it and a designated secret number or indicia recognized by the issuing credit card company, financial institution or bank identified through recognized means that can be related or unrelated to persons' personal information, including name, social security number or birth date.

16. The medium set forth in claim 15 wherein the said tangible or intangible medium or its pre-designated monetary value will be exchanged for a fee.

17. The medium set forth in claim 15 wherein the said tangible or intangible medium or its pre-designated monetary value will be used online or offline.

18. The medium set forth in claim 15 wherein the said tangible or intangible medium or its pre-designated monetary value will be used as a commodity.

19. The medium set forth in claim 15 wherein the said tangible or intangible medium or its pre-designated monetary value will be exchanged to obtain goods or services.

20. The medium set forth in claim 15 wherein the said tangible or intangible medium or its pre-designated monetary value will be cashed.

21. The medium set forth in claim 15 wherein the said tangible or intangible medium or its pre-designated monetary value will be issued by a credit card company, financial institution or a bank.
